(19) United States
(12) Patent Application Publication
(10) Pub. No.: US 2018/0239583 A1
(43) Pub. Date: Aug. 23, 2018

(54) VOICE CONTROL OF A PRINTER UNIT

(71) Applicant: Hewlett-Packard Development Company, L.P., Houston, TX (US)

(72) Inventors: Raimon Castells De Monet, Sant Cugat del Valles (ES); Aviv Hassidov, Sant Cugat del Valles (ES); Abel Martinez-Guillen, Sant Cugat del Valles (ES)

(73) Assignee: Hewlett-Packard Development Company, L.P., Houston, TX (US)

(21) Appl. No.: 15/754,219

(22) PCT Filed: Sep. 2, 2015
(86) PCT No.: PCT/US2015/048058

§ 371 Date: Feb. 21, 2018

(51) Int. Cl. G06F 3/16; G06F 3/12; G10L 15/26; G06F 17/30

(52) U.S. Cl. CPC G06F 3/167; G06F 3/1284; G10L 2015/223; G10L 15/26; G06F 17/30985; G06F 3/1204

(57) ABSTRACT

Example techniques for the voice control of a printer unit are disclosed. A method includes receiving a vocal communication. The vocal communication is parsed into a text string. The text string is matched to a word having a predefined meaning. The word is converted into a printer command and the printer command is sent to the printer unit.

### BACKGROUND

Printer technology is becoming more sophisticated as new printer units are developed. Addition of the new printer units to printing lines may result in increasingly larger printing lines.

### DESCRIPTION OF THE DRAWINGS

Certain examples are described in the following detailed description and in reference to the drawings, in which:

FIG. 1 is a schematic of an example of a voice control system for controlling a printer unit;

FIG. 2A is a block diagram of an example of a printing control system for voice control of the printer units;

FIG. 2B is a block diagram of an example of a printing control system for voice control of a printer unit;

FIG. 3 is a table of words that may be used in a printing control system for voice control of a printer unit;

FIG. 4 is a schematic of a printing control system for voice control of multiple large printers;

FIG. 5A is a process flow diagram of an example method for voice control of a large printer;

FIG. 5B is a process flow diagram of an example method for voice control of a large printer;

FIG. 6A is a block diagram of an example of a non-transitory, computer readable medium that includes code to direct a processor to forward a compound printing command to a target large printer; and

FIG. 6B is a block diagram of an example of a non-transitory, computer readable medium that includes code to direct a processor to convert a vocal communication into a printer command.

### DETAILED DESCRIPTION

A printer is used to form text and images on a substrate, such as paper, to form a finished product. Printers may range from small desktop or office units to large scale printers, for example, used in commercial printing operations. A large scale printer may include a number of integrated printer units. Further, in some examples, a printing line may be composed of individual printer units that perform specific functions in converting the substrate into a finished product. The printing line may be configurable by moving and interconnecting printing units. As used herein, the term large printer encompasses both printing lines and large scale printers. As used herein, a printer unit is a physical device that performs functions in the printing operations, such as moving a substrate through the large printer or forming images on the substrate, among others.

A user interface is generally located in a fixed location on a large printer or a printer unit. An operator often has to walk around a large printer to get to the user interface. During some operations, the operator may need to move around the large printer numerous times to reach the user interface and enter commands. The back-and-forth movement of the operator may be time consuming. Further, some operations may use both of the operator's hands, making it difficult for the operator to access the user interface when a command may need to be issued.

As an example, feeding paper from a paper roll into an unwinder unit may be challenging. Paper rolls may be bulky and difficult to manipulate. Further, the user interface may be located away from the paper loading area of the unwinder unit. When an operator is feeding the paper, certain actions such as moving the paper forward or backwards or stopping it may be used. As a result, the operator may need to leave the loading area of the unwinder unit, move to the user interface, enter the appropriate command, and return to the loading area to continue with the feeding operation. The operator may move between the loading area and the user interface a number of times. Further, the operator may need to use both his hands to ensure good alignment between the paper roll and the unwinder unit. Letting go of the roll to move to the user interface can cause misalignments and printing errors. The result may result in a loss of time, material, and money.

As described herein, a printing control system may be used to control a printer unit in a large printer. In some examples, multiple large printers may be controlled by selecting a target large printer to receive the command. The system may enable wireless communication between an operator and the printer unit. The operator may use a wireless headset with a microphone to issue commands to the printer unit and receive information on the status of the printer unit. With the printing control system, the operator can issue commands and receive information no matter where he is situated around the large printer.

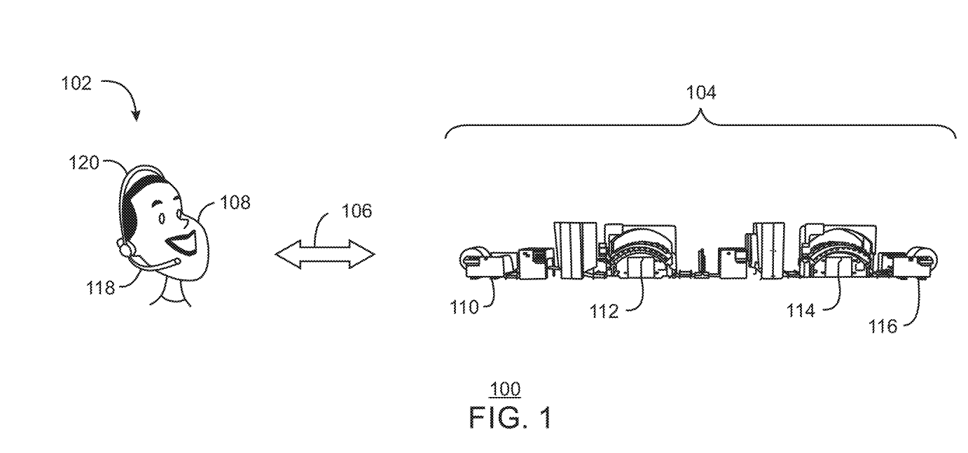

FIG. 1 is a schematic drawing 100 of an example of a voice control system 102 for controlling a large printer 104. The voice control system 102 may enable two-way communications 106 between an operator 108 and printer units 110, 112, or 114 that may be included in the large printer 104. For example, the large printer 104 may include several printer units including an unwinder 110, an inline priming unit, at least one printer 112 and 114, a buffer control unit with or without a turn bar, a rewinder 116, and the like.

The operator 108 may speak into the microphone 118 of a wireless headset 120 and issue a command to a printer unit 110, 112, 114, or 116. The printer unit 110, 112, 114, or 116 may execute the command and communicate to the operator 108 when execution is complete. If a problem in execution of the command is about to occur, the printer unit 110, 112, 114, or 116 may communicate a warning message to the operator 108. If a problem occurs and the printer unit 110, 112, 114, or 116 stops during execution of the command, the printer unit 110, 112, 114, or 116 may communicate an error message to the operator 108. It may be understood that the printer unit 110, 112, 114, or 116 may be under control of the voice control system 102. In this example, the voice control system 102 detects the error and informs the operator of the fault.

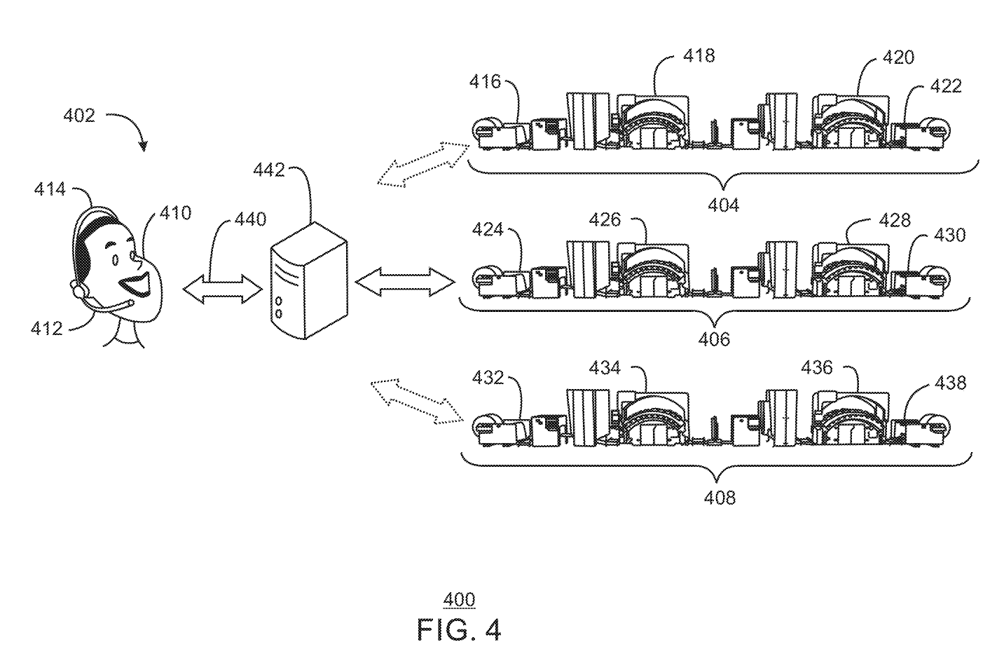

In the example shown in FIG. 1, the voice control system 102 may control the printer units 110, 112, 114, or 116 included in a large printer 104. The voice control system 102 may also be used to control the printer units included in multiple large printers as described further with respect to FIG. 4.

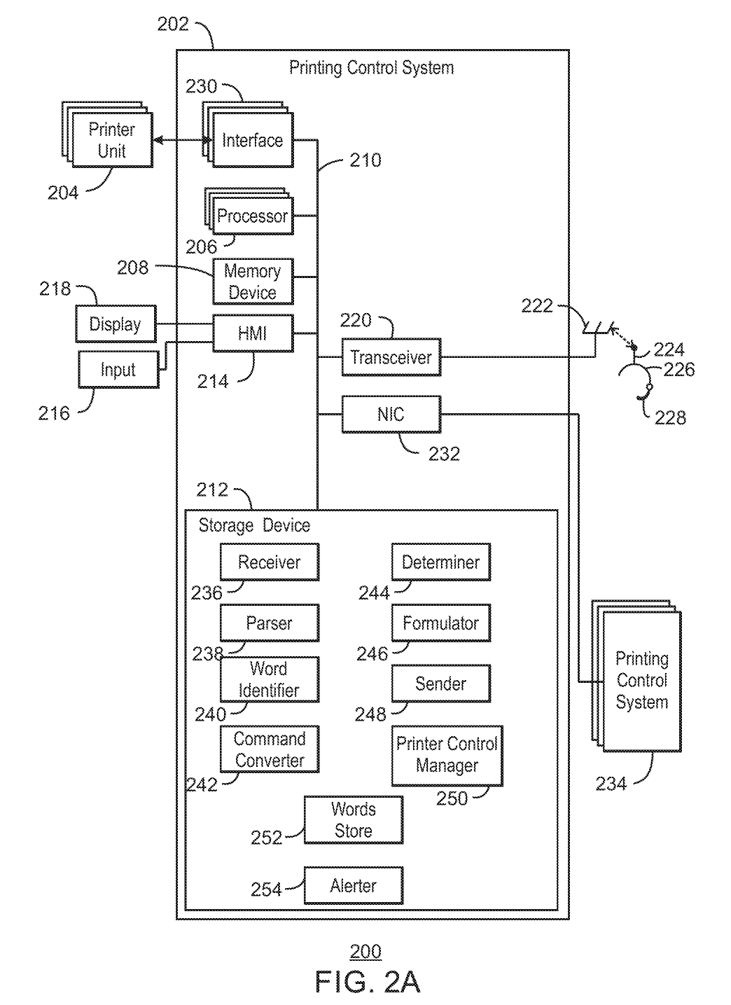

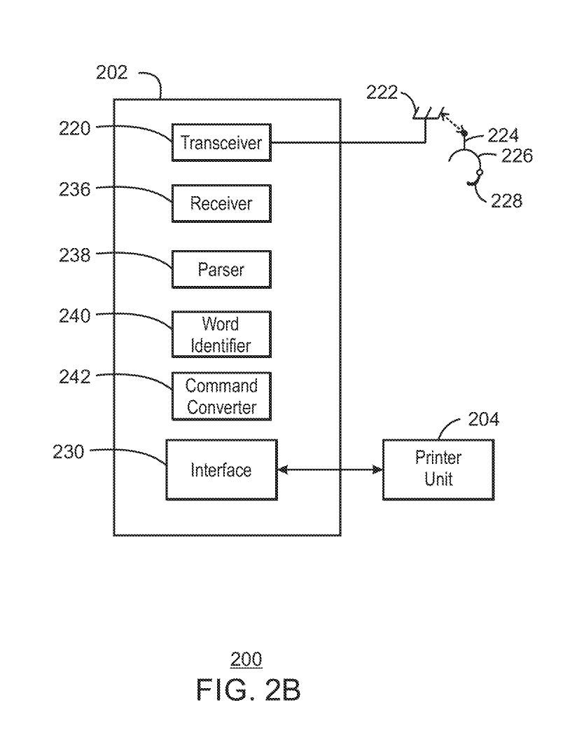

FIG. 2A is a block diagram 200 of an example of a printing control system 202 for voice control of the printer units 204 included in a large printer. The printing control system 202 may include a processor 206 that is configured to execute stored instructions, as well as a memory device 208 that stores instructions executable by the processor 206. The processor 206 can be a single core processor, a dual-core processor, a multi-core processor, a computing cluster, or the like. The processor 206 may be coupled to the memory device 208 by a bus 210 where the bus 210 may be a communication system that transfers data between various components of the printing control system 202. In examples, the bus 210 may be a Peripheral Component Interconnect (PCI), Industry Standard Architecture (ISA), PCI-Express, or the like.

The memory device 208 can include random access memory (RAM), e.g. Static RAM (SRAM), Dynamic RAM (DRAM), Zero Capacitor RAM, Embedded DRAM (eDRAM), Extended Data Out RAM (EDO RAM), Double Data Rate RAM (DDR RAM), Resistive RAM (RRAM), and Parameter RAM (PRAM); read only memory (ROM), e.g., Mask ROM, Programmable ROM (PROM), Erasable Programmable ROM (EPROM), and Electrically Erasable Programmable ROM (EEPROM); flash memory; or any other suitable memory system. The printing control system 202 may also include a storage device 212. The storage device 212 may include non-volatile storage devices, such as a solid-state drive, a hard drive, a tape drive, an optical drive, a flash drive, an array of drives, or any combinations thereof.

The processor 206 may be connected through the bus 210 to a human machine interface (HMI) 214 configured to couple the printing control system 202 to an input device 216. The input device 216 may include a keyboard, a mouse, or a pointing device, and the like. The pointing device may include a touchpad or a touchscreen. The HMI 214 may include a display driver to couple the printing control system 202 to a display device 218. The display device 218 may include a display screen, a computer monitor, a touchscreen, a television, or a projector, among others.

The processor 206 may be connected to a transceiver 220 via bus 210. The transceiver 220 may have an antenna 222 which communicates with an antenna 224 on a wireless headset 226. The transceiver 220 may comprise radio frequency technology, WIFI, Bluetooth, or any combinations thereof. The wireless headset 226 may include a microphone 228 which enables the operator to issue a command to the printer unit 204. The command may be converted into a command understandable by the printer unit 204 and communicated to the printer unit 204 via an interface 230.

A network interface controller (NIC) 232 may also be linked to the processor 206. The NIC 232 may allow the printing control system 202 to communicate with printing control systems 234 for other large printers. In this fashion, a single operator may control multiple large printers.

The storage device 212 may include a number of modules configured to provide the printing control system 202 with the capability to convert spoken words into commands understandable by a printer unit 204. For example, a receiver 236 may receive a vocal communication from a wireless headset 226 with a microphone 228. A parser 238 may generate a text string from the vocal communication. A word identifier 240 may match the text string to a word having a predefined meaning. The word may be translated into a printer command by a command converter 242. The identity of the target printer unit 204 may be identified by a determiner 244. A formulator 246 may create a compound printer command that includes the identity of the target printer unit 204. The compound printer command may be conveyed by a sender 248 to the printer control manager 250. The printer control manager 250 may forward the compound printer command to the target printer unit 204.

The storage device may include a words store 252 that contains words having predefined meanings. The word identifier 240 may translate text strings into words contained in the words store 252. The words may then be translated into printer commands by the command converter 242.

The storage device may also include an alerter 254. The alerter 254 may send information from the printer unit 204 to the wireless headset 226. The information may concern the status of the printer unit 204. The information may comprise a warning message or an error message.

The block diagram of FIG. 2A is not intended to indicate that the printing control system 202 must include all of the components shown in the figure. For example, the determiner 244 and the formulator 246 may not be used in some implementations, as shown in the example in FIG. 2B. Further, any number of additional components may be included within the printing control system 202, depending on the details of the specific implementation.

FIG. 2B is a block diagram 200 of an example of a printing control system 202 for voice control of a printer unit 204. Like numbered items are as described with respect to FIG. 2A. Not all items will be present in all examples. For example, as shown in FIG. 2B, a simplified system may include a transceiver, receiver, parser, word identifier, command converter, and interface and not include various modules, such as a sender and a printer control manager.

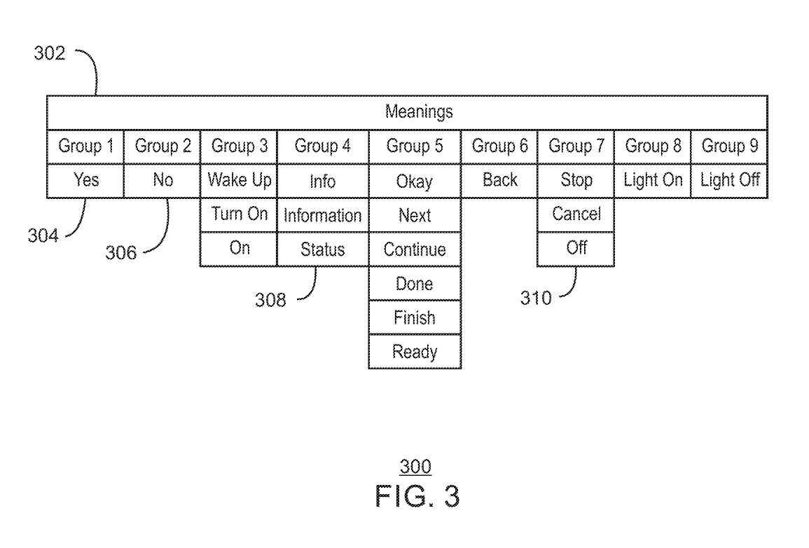

FIG. 3 is a table of words 302 that may be used in a printing control system for voice control of a printer unit. In this example, the table of words 302 contains twenty words placed in nine columns. Words in the same column have the same predefined meaning, e.g., perform the same action for a printer unit. For example, the operator speaks the word “yes” 304 in group 1 or the word “no” 306 in group 2 to answer queries from the printer unit. The word “status” 308 in group 4 is used to inquire as to the status of the printer unit. The word “off” 310 in group 7 is spoken by the operator to halt the operation of the printer unit.

A vocal communication from an operator may be converted into a word from the table of words 302 by the printing control system. The word from the table of words 302 may then be translated into a printer command, which may be sent to a printer unit for execution or executed by the printing control system itself. Hence, the words from the table of words 302 may be used for vocal communication to control a printer unit.

FIG. 4 is a schematic 400 of a printing control system 402 for voice control of multiple large printers 404, 406, and 408. The operator 410 may speak into the microphone 412 of a wireless headset 414 and may issue a communication including an indication of which of the large printers 404, 406, or 408 is the target for the voice command. The operator may also indicate which of the printer units 416-438 included in the large printers 404, 406, and 408 is the target printer unit. For example, as described herein, the printing line 404 may be comprised of several printer units including an unwinder 416, an inline priming unit, at least one printer 418 and 420, a buffer control unit with or without a turn bar, a rewinder 422, and the like. Any of these printing units or their counterparts in the large printers 406 and 408 may be the target printer unit.

The communication may be conveyed 440 to a processing unit 442. For example, the processing unit 442 may be the printing control system 202 described with respect to FIG. 2A. In this example, the other lines may be controlled by communications transferred to other printing control systems 234. The processing unit 442 may convert the communication into a printer command and formulate a compound printer command that contains the printer command and the identities of the target large printer 404, 406, or 408 and the target printer unit, e.g., unwinder 416, printer 418, printer 420, or rewinder 422, among others. The processing unit 442 may forward the compound printer command to the target large printer 404, 406, or 408 and ultimately the target printer unit.

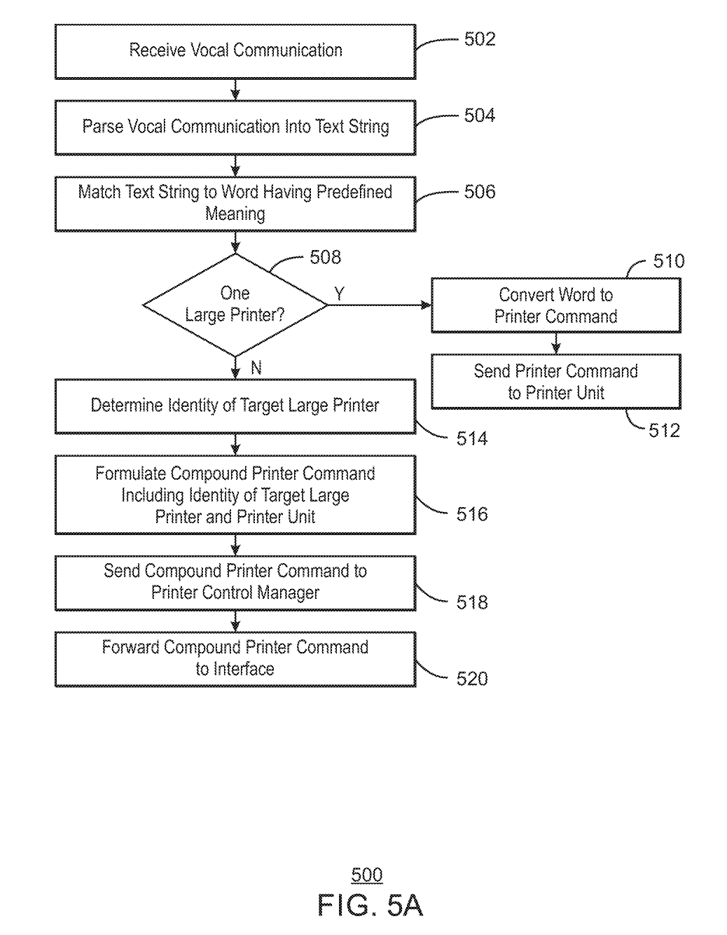

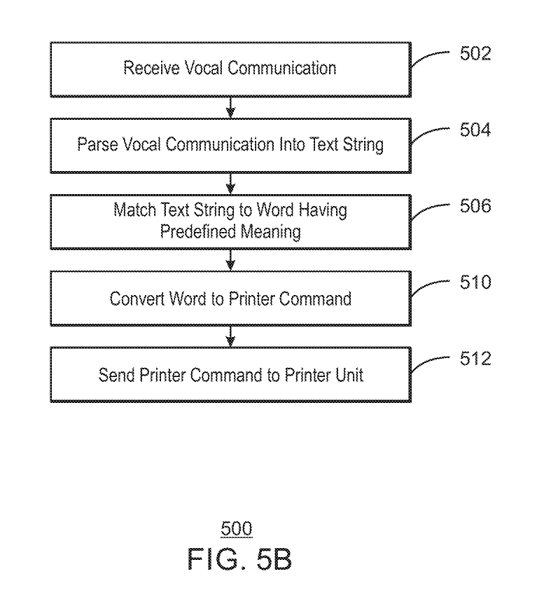

FIG. 5A is a process flow diagram of an example method 500 for voice control of a large printer. The method 500 may be performed by the printing control system 202 in FIG. 2A. In this example, the method 500 begins at block 502 with the receiving of a vocal communication. The vocal communication is received from an operator using a wireless headset with a microphone. At block 504, the vocal communication is parsed into a text string. The text string comprises the relevant portion of the vocal communication. At block 506, the text string is matched to a word having a predefined meaning. For example, the word may be one of the twenty words listed in the table in FIG. 3.

At block 508, it is determined whether one large printer or multiple large printers are being controlled by the operator. The method 500 proceeds to block 510 if only one large printer is involved. At block 510, the word with the predefined meaning is converted to a printer command for a printer unit in the large printer. At block 512, the printer command is sent to the printer unit. The printer command may include the identity of the single large printer.

The method 500 continues at block 514 if it was determined at block 508 that multiple large printers are involved. At block 514, the identity of the target large printer is determined. The target large printer is the one printer unit of the multiple large printers that the operator intends to control. At block 516, a compound printer command is formulated. The formulation at block 516 includes a step whereby the word from block 506 is converted into a printer command for a printer unit in the target large printer. This printer command is part of the compound printer command. The other component of the compound printer command is the identity of the target large printer. The compound printer command is sent to the printer control manager of the target large printer at block 518. At block 520, the printer control manager forwards the compound printer command to the interface for the target large printer.

FIG. 5A is not intended to imply that every block is needed or that additional blocks may not be added. For example, a network interface controller may enable the printing control system to control another large printer via a printing control system for the other large printer. Further, some blocks in FIG. 5A, such as blocks 508, 514, 516, 518, and 520, may be omitted if a single large printer is being controlled.

FIG. 5B is a process flow diagram of an example method 500 for voice control of a single large printer. The method is comprised of blocks 502-506, 510, and 512. Like numbered items are as described with respect to FIG. 5A.

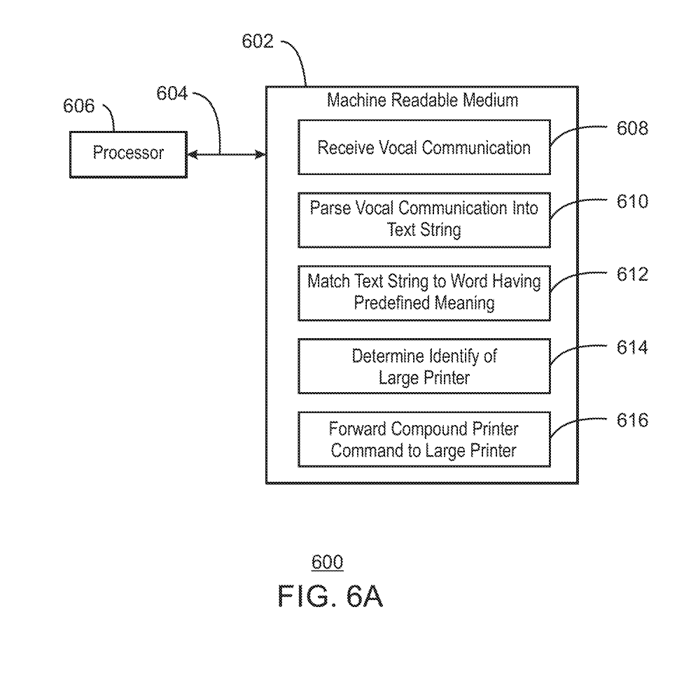

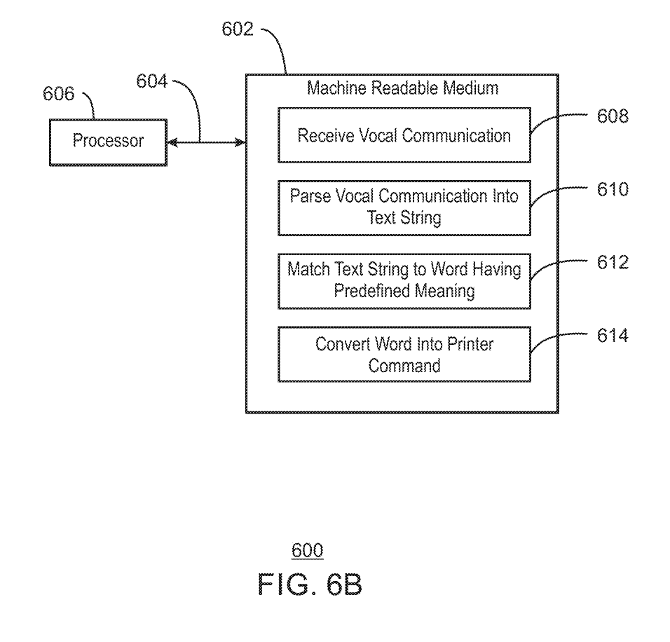

FIG. 6A is a block diagram 600 of an example of a non-transitory, computer readable medium 602 that includes code for voice control of a large printer. The code may direct a processor to forward a compound printing command to a large printer. The non-transitory, computer readable medium 602 is coupled to a bus 604 and to a processor via the bus 604. The non-transitory, computer readable medium 602 may include code 608 to direct the processor 606 to receive a vocal communication. Further, code 610 may direct the processor to parse the vocal communication into a text string. Code 612 may be included to direct the processor to match the text string to a word having a predefined meaning. Code 614 may also be included to direct the processor to determine the identity of the large printer. Code 616 may direct the processor to forward a compound printer command to a large printer.

FIG. 6B is block diagram 600 of an example of a non-transitory, computer readable medium 602 that includes code to direct a processor to convert a vocal communication into a printer command. Like numbered items are as described with respect to FIG. 6A. In this example, the code may be used to control a printer unit included in a single large printer, and thus, code directed to multiple large printers may not be present.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the scope of the present techniques.

What is claimed is:

1. A printing control system for voice control of a large printer, comprising:
a receiver to receive a vocal communication from a wireless headset with a microphone;
a parser to generate a text string from the vocal communication;
a word identifier to match the text string to a word having a predefined meaning;
a command converter to translate the word into a printer command; and
an interface to send the printer command to the printer unit.

2. The printing control system of claim 1, further comprising a transceiver to communicate between the wireless headset and the receiver.

3. The printing control system of claim 2, wherein the transceiver comprises radio frequency technology.

4. The printing control system of claim 1, comprising an alerter to send information to the wireless headset.

5. The printing control system of claim 4, wherein the information comprises a warning message.

6. The printing control system of claim 4, wherein the information comprises an error message.

7. The printing control system of claim 1, further comprising a network interface controller to communicate with another printing control system.

8. The printing control system of claim 1, further comprising:
a determiner to establish an identity of a target printer unit;
a formulator to create a compound printer command including the identity of the target large printer;
a sender to convey the compound printer command to a printer control manager; and
the printer control manager to forward the compound printer command to the target large printer.

9. The printing control system of claim 8, wherein the printer control manager comprises a processor, a memory, and a human machine interface.

10. A method for voice control of a printer unit, comprising:
receiving a vocal communication;
parsing the vocal communication into a text string;
matching the text string to a word having a predefined meaning;
converting the word into a printer command; and
sending the printer command to the printer unit.

11. The method of claim 10, further comprising receiving information via a wireless headset.

12. The method of claim 10, further comprising:
determining an identity of a target large printer;
formulating a compound printer command including the identity of the target large printer;
sending the compound printer command to a printer control manager; and
forwarding the compound printer command to an interface by the printer control manager.

13. A non-transitory, computer readable medium comprising machine-readable instructions for voice control of a printer unit, the instructions, when executed, direct a processor to:
receive a vocal communication;
parse the vocal communication into a text string;
match the text string to a word having a predefined meaning; and
convert the word into a printer command.

14. The non-transitory, computer readable medium comprising machine-readable instructions for voice control of a printer unit of claim 13, further comprising code to direct the processor to:
determine an identity of a large printer; and
forward a compound printer command to the large printer.

15. The non-transitory, computer readable medium comprising machine-readable instructions for voice control of a printer unit of claim 13, further comprising code to direct the processor to send the printer command to the printing unit.
